(19) United States
(12) Patent Application Publication
(10) Pub. No.: US 2018/0107985 A1
(43) Pub. Date: Apr. 19, 2018

(54) AUTOMATIC UPDATE OF CALENDAR EVENT

(71) Applicant: MICROSOFT TECHNOLOGY LICENSING, LLC, Redmond, WA (US)

(72) Inventors: Roshin Lal Ramesan, Redmond, WA (US); Juan Diego Ferre, Seattle, WA (US)

(73) Assignee: MICROSOFT TECHNOLOGY LICENSING, LLC, Redmond, WA (US)

(21) Appl. No.: 15/292,141

(22) Filed: Oct. 13, 2016

(51) Int. Cl. G06Q 10/10; H04L 12/58

(52) U.S. Cl. CPC G06Q 10/1095; H04L 51/08

(57) ABSTRACT

Variety of approaches to automatically update a calendar event are described. A productivity service initiates operations to automatically update a calendar event by processing a content of a received email. Event information is identified within the content of the email. The event information relates to the calendar event. Next, an update to the calendar event is detected within the event information. The update is applied to the calendar event.

### BACKGROUND

Information exchange through a variety of communication modalities has changed processes associated with work and personal environments. Automation and process enhancements have expanded scope of capabilities offered for information consumption in personal and business scenarios. With the development of faster and smaller electronics, execution of mass processes at cloud systems have become feasible. Indeed, applications provided by data centers, data warehouses, data workstations have become common features in modern personal and work environments. Such systems execute a wide variety of applications ranging from enterprise resource management applications to personal productivity tools. Many such applications manage calendar events. Calendar event management consume significant resources and performance at a promise of improved user productivity.

Improved calendar event management techniques are becoming ever more important as communication complexity increases across the computer industry. Variety of techniques are necessary to setup a calendar event, to maintain the calendar event, and to update the calendar event. There are currently significant gaps when updating a calendar event with information received from external entities. Lack of relevant update methods lead to poor management of timed resources when managing a calendar event.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an automated update of a calendar event. A productivity service, according to embodiments, may initiate operations to automate an update of the calendar event by processing a content of a received email. Event information may be identified within the content of the email. The event information may relate to the calendar event. Next, an update to the calendar event may be detected within the event information. The update may be applied to the calendar event.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of automatically updating a calendar event, according to embodiments;

FIG. 2 is a display diagram illustrating example components of a productivity service that automatically updates a calendar event with an update signal from a service provider, according to embodiments;

FIG. 3 is a display diagram illustrating components of a scheme to automatically update a calendar event with an update signal from a service provider, according to embodiments;

FIG. 4 is a display diagram illustrating components of a scheme to automatically update a calendar event with an update detected within an email, according to embodiments;

FIG. 5 is a simplified networked environment, where a system according to embodiments may be implemented;

FIG. 6 is a block diagram of an example computing device, which may be used to automatically update a calendar event, according to embodiments;

FIG. 7 is a logic flow diagram illustrating a process for automatically updating a calendar event with an update signal, according to embodiments; and

FIG. 8 is a logic flow diagram illustrating a process for automatically updating a calendar event with an update detected within an email, according to embodiments.

### DETAILED DESCRIPTION

As briefly described above, a productivity service may automatically update a calendar event. In an example scenario, the productivity service may process a content of a received email. Event information may be identified within the content of the email. The event information may relate to the calendar event. Next, an update to the calendar event may be detected within the event information. The update may include a change to a location, a duration, a start time, an end time, an event name, the service provider, and/or a task, among others associated with the calendar event. The update may be applied to the calendar event.

In an alternative scenario, the productivity service may automatically update a calendar event by analyzing the calendar event to identify a contextual information associated with the calendar event. The contextual information may be detected with a machine learning scheme. The contextual information may also include a description of a location, a duration, a start time, an end time, an event name, the provider, a task, and or similar ones associated with the calendar event.

The productivity service may query a service provider associated with the contextual information for an update signal associated with the calendar event. The service provider may be identified within the contextual information. Alternatively, an active subscription to the service provider may be used to establish an association between the service provider and the calendar event. Next, the update signal associated with the calendar event may be received. The update signal may include a change to an attribute of the calendar event such as a location, a start time, an end time, and/or a duration, among others. The calendar event may be updated based on the update signal.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including band-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions tear causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to automatically update a calendar event. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display, a non-visual display (for impaired users as an example), and/or other user experience associated with an application or service through which a use interacts with the application or service. A user action refers to an interaction between a user and a user experience of an application or a user experience provided by a service that includes touch input, gesture input, voice command, eye tracking, gyroscopic input, pen input, mouse input, and/or keyboards input, among others. An application programming interface (API) may be a set of routines, protocols, and tools for an application or service that enable the application or service to interact or communicate with one or more other applications and services managed by separate entities.

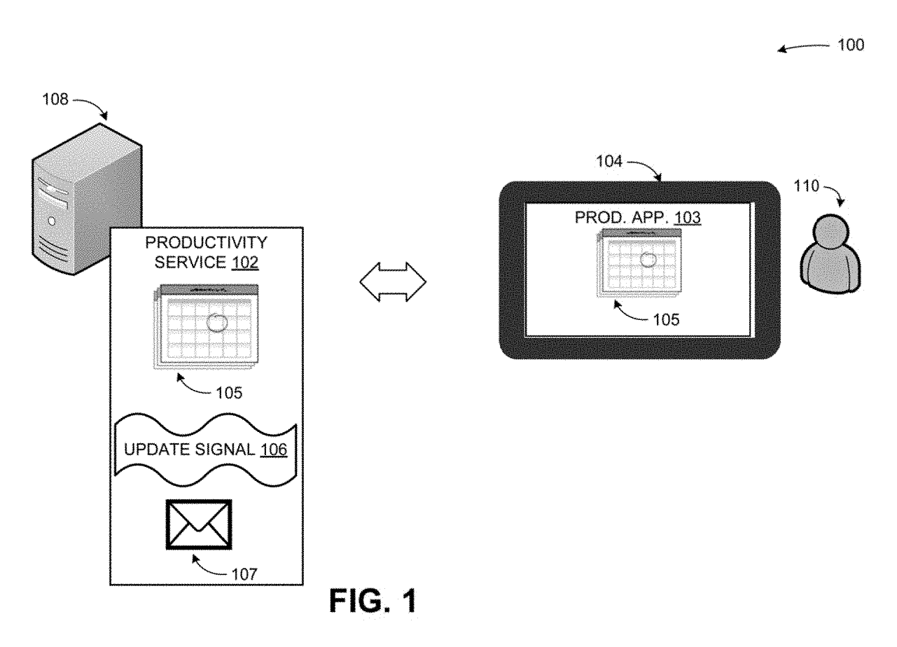

FIG. 1 is a conceptual diagram illustrating examples of automatically updating a calendar event, according to embodiments.

In a diagram 100, a physical server 10$ may execute a productivity service 102. The physical server 108 may include a physical server providing service(s) and/or application(s) to client devices. A service may include an application performing operations in relation to a client application and/or a subscriber, among others. The Physical server 108 may include and/or is part of a workstation, a data warehouse, a data center, and/or a cloud based distributed computing source, among others.

The physical server 108 may execute the productivity service 102. The productivity service 102 may initiate operations to automatically update a calendar event 105 by analyzing the calendar event 105 to identify a contextual information associated with the calendar event 105. The contextual information may include a description of a location, a duration, a start time, an end time, an event name, a service provider, and/or a task, among others associated with the calendar event 105.

The productivity service 102 may query a service provider associated with the contextual information for an update signal 106 associated with the calendar event 105. The update signal 106 may include a change to an attribute of the calendar event 105. For example, the update signal 106 may include a flight delay for an upcoming flight (the calendar event 105). The productivity service 102 may receive the update signal 106 associated with the calendar event 105. The calendar event 105 may be updated based on the update signal 106.

The productivity service 102 may also process a content of an email 107 upon receiving the email 107. The content may include event information which relates to the calendar event 105. An update to the calendar event 105 may be detected within the event information. The update may be applied to the calendar event 105. For example, the email 107 may describe a delivery time change for an expected delivery of an item (the calendar event 105). The delivery time change may be applied to the calendar event 105 to update the calendar event 105.

The physical server 108 may communicate with the client device 104 through a network. The network may provide wired or wireless communications between network nodes such as the client device 104 and/or the physical server 108, among others. Previous example(s) to automatically update the calendar event 105 are not provided in a limiting sense. Alternatively, the productivity service 102 may automatically update the calendar event 105 as a desktop application, a workstation application, and/or a server application, among others. The productivity application 103 and may also include a client interface of the productivity service 102. The productivity application 103 may be rendered by the client device 104 to present the calendar event 105 and any update automatically applied to the calendar event 105 to an event participant 110.

The event participant 110 may interact with the productivity application 103, respectively, with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the physical server 108, the productivity service 102, embodiments are not limited to these components or system configurations and can be implemented with other system configuration employing fewer or additional components.

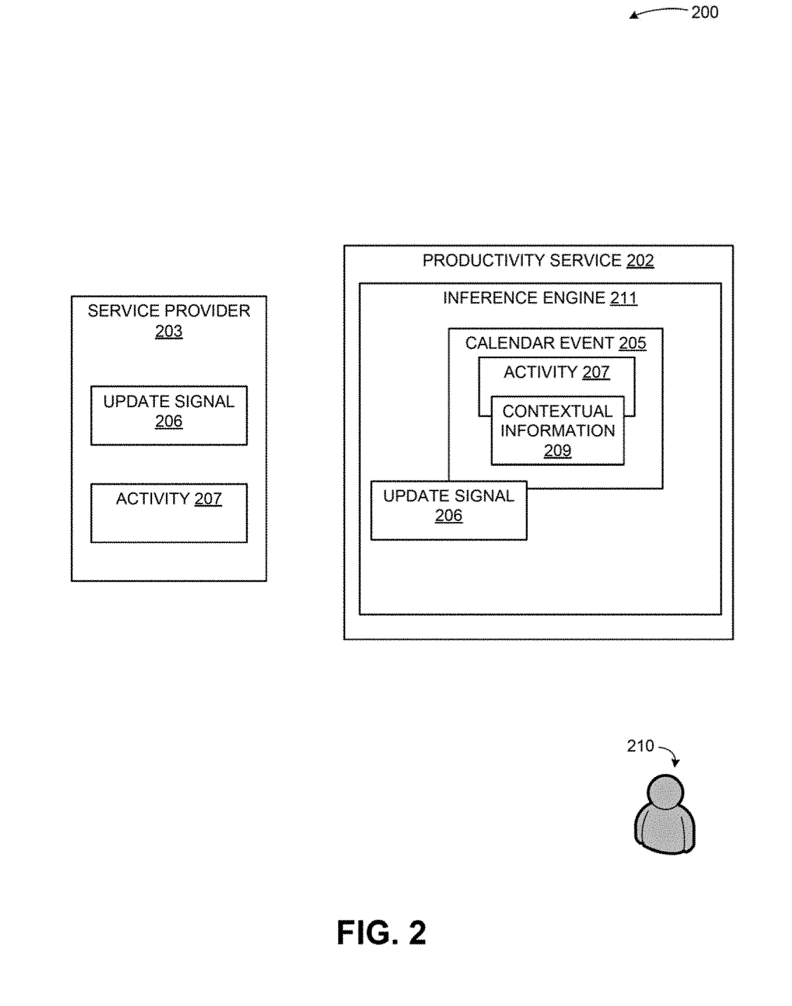

FIG. 2 is a display diagram illustrating example components of a productivity service that automatically updates a calendar event with an update signal from a service provider, according to embodiments.

In a diagram 200, an inference engine 211 of a productivity service 202 may process a content of a calendar event 205 with a machine learning scheme to identify a contextual information 209. The machine learning scheme may include a linear, regression, a logistic regression, a decision tree, a support vector machine, a naïve, a K-Nearest neighbors, a K-Means, a random forest, a dimensionality reduction, and/or a gradient boost, among other schemes to process the content of the calendar event 205. The content of the calendar event may be processed to identify the contextual information 209 which may include a location, a duration, a start time, an end time, an event name, the service provider, and/or a task, among others associated with the calendar event 205.

Identification information associated with a service provider 203 may be detected within the contextual information 209. The service provider 203 may provide an update signal 206 associated with the calendar event 205. For example, a tracking site (the service provider 203) may provide tracking status (the update signal 206) associated with a scheduled item delivery (calendar event 205).

The inference engine 211 may find the service provider 203 with the identification information detected in the contextual information 209. Next, a communication may be established with the service provider 203 to query for the update signal 206. Alternatively, the service provider 203 may be queried by identifying a subscription to the service provider 203. An association between the service provider 203 and the calendar event 205 may be verified based on the contextual information 209 through the subscription. For example, the contextual information 209 may include identification information (a name, and/or an identifier) associated with the service provider 203.

The inference engine 211 may also process the update signal 206 and detect a change to an attribute of the calendar event 205 within the update signal 206. The attribute may include a start time, an end time, and/or a duration, among others associated with the calendar event 205. The change may be applied to the attribute of the calendar event 205 to update the calendar event 205.

In an example scenario, a conflict between the calendar event 205 and another calendar event may be detected. The conflict may occur as a result of the automatic update to the calendar event 205 which may have changed an attribute of the calendar event 205 to overlap with the other calendar event. To address the conflict, the inference engine 211 may identify an activity 207 within the calendar event 205. The activity 207 may be reserved with the service provider 203. For example, a flight (the activity 207) reserved with an airline website (the service provider 203). The productivity service 202 may transmit a notification to the service provider 203 to re-schedule the activity 207 to resolve the conflict. The productivity service 202 may define parameters to re-schedule the activity 207 within the notification (such as a time frame during which an event participant 210 may be available for the activity 207).

Upon receiving a re-schedule confirmation from the service provider 203, the inference engine 211 may update the calendar event 205 based on a new start time, a new end time, and/or a new duration, among other attributes associated with the activity 207 that re-scheduled. Alternatively, upon receiving a failure notification to re-schedule the activity 207 from the service provider 203, the inference engine 211 may remove the calendar event 205. In another example scenario, the inference engine 211 may transmit a notification to alert the event participant 210 of the conflict to prompt the event participant 210 to resolve the conflict. In such a scenario, the inference engine 211 may provide suggestion(s) to the event participant 210 to execute alternative action(s) such as reschedule the calendar event 205 and/or remove the calendar event 205, among others. Examples of the activity 207 may include a travel related booking, a meeting, an item tracking, and/or a task, among others.

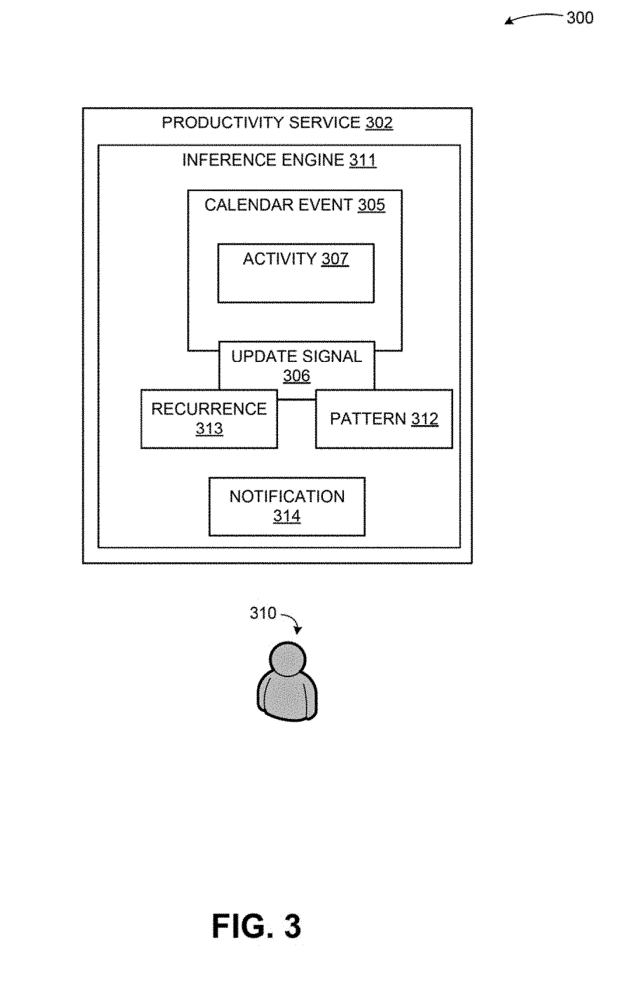

FIG. 3 is a display diagram illustrating components of a scheme to automatically update a calendar event with an update signal from a service provider, according to embodiments.

In a diagram 300, an inference engine 311 of a productivity service 302 may process an update signal 306 to detect other activity associated with an activity 307 within the update signal 306. In response, other calendar event may be scheduled to encapsulate the other activity. For example, the inference engine 311 may detect a return flight (the other activity) within a check-in notification (the update signal 306) from an airline service (a service provider) in relation to an upcoming flight (the activity 307).

The inference engine 311 may also detect a pattern 312 associated with an event participant 310 based on the updated signal 306. For example, a reminder for a doctor's appointment (the update signal 306) may list scheduled appointments (the pattern 312). Next, the inference engine 311 may transmit a notification 314 to the event participant 310. The notification 314 may request the event participant 310 to authorize creation of a new calendar event based on the pattern 312. Upon receiving an approval notification from the event participant 310, the new calendar event may be created based on the pattern 312. Alternatively, the inference engine 311 may automatically create the new calendar event without any input from the event participant 310.

In another example scenario, the inference engine 311 may detect a recurrence 313 associated with the activity 307 within the update signal 306. For example, a scheduled delivery of an item may be listed to recur every week within the update signal 306. Next, the inference engine 311 may schedule other calendar event(s) associated with the calendar event 305. The calendar event 305 and other calendar event(s) may replicate the recurrence 313, The inference engine 311 may also transmit a notification 314 to the event participant 310 to request the event participant 310 to verify the other calendar event(s). Upon receiving the approval notification from the event participant 310, the other calendar event(s) may be created. Alternatively, the inference engine 311 may automatically create the other calendar event(s) without any input from the event participant 310.

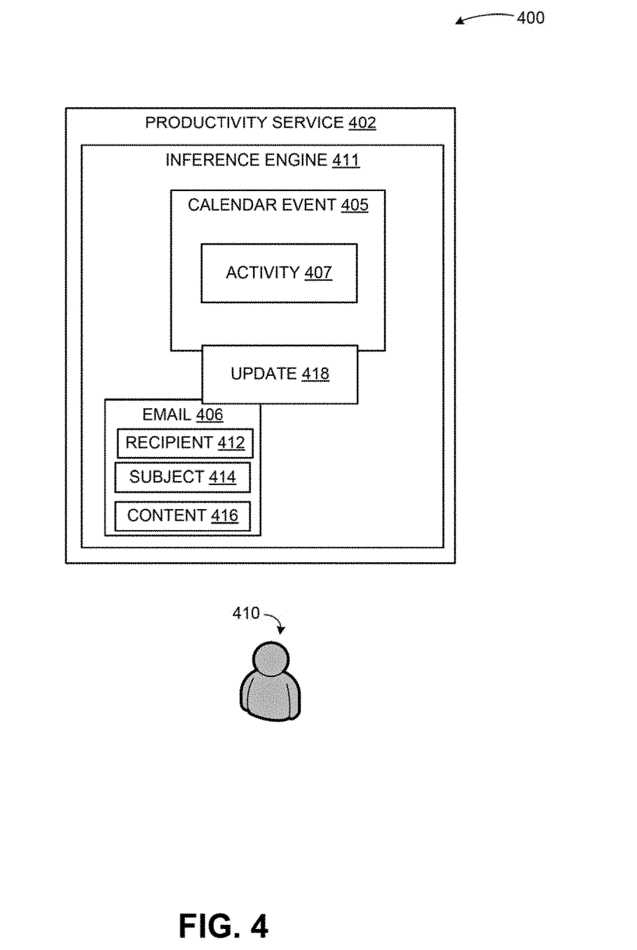

FIG. 4 is a display diagram illustrating components of a scheme to automatically update a calendar event with an update detected within an email, according to embodiments.

In a diagram 400, an inference engine 411 of a productivity service 402 may process a content 416 of an email 406 upon receiving the email 406. Event information related to the calendar event 405 may be identified within the content 416. An update 418 to the calendar event 405 may be detected within the event information. Next, the update 418 may be applied to the calendar event 405. The update may include a change to a location, a duration, a start time, an end time, an event name, the provider, and/or a task, among others associated with the calendar event 405.

The inference engine 411 may also process the content 416 of the email 406 with a machine learning scheme to identify the update 418 to the calendar event 405. In an example scenario, a recipient 412 of the email may be matched to an event participant 410 of the calendar event 405. Furthermore, a contextual information associated with a subject 414 of the email 406 may be correlated with a contextual information associated with a description of the calendar event 405. For example, an email 406 addressed to the recipient 412 (who matches the event participant 410) may be processed to detect a correlation between a subject 414 of the email 406 and the description of the calendar event 405. In such a scenario, the content 416 of the email 406 ay be processed by a machine learning scheme to identify the update 418 to the calendar event 405.

The inference engine 411 may further process a content of a new email to identify event information within the content. A new update to the calendar event 405 may be detected within the event information. The new update may be applied to the calendar event 405.

In another example scenario, the inference engine 411 may process the content 416 of the email 406 to detect a change to an attribute of the calendar event 405 within the content 416. The attribute may include a start time, an end time, and/or a duration, among other attributes of the calendar event 405. The change to the attribute may be applied to the calendar event 405.

The inference engine may also detect other activity associated with the activity 407 within the content 416 of the email 406. Other calendar event may be scheduled to encapsulate the other activity. In another example scenario, a pattern associated with a recipient 412 of the email 406 may be identified based on the content 416 of the email 406. In such a scenario, a notification may be transmitted to the recipient to authorize creation of a new calendar event based on the pattern. Upon receiving an approval notification from the event participant, the inference engine 411 may create the new calendar event based on the pattern. Alternatively, the inference engine 411 may create the new calendar event automatically without any input from the event participant 410.

In another example scenario, the inference engine 411 may detect a recurrence associated with the activity 407 within the content 416 of the email 406. Other calendar event(s) associated with the calendar event 405 may be scheduled. The calendar event 405 and the other calendar event(s) may replicate the recurrence. A notification may also be transmitted to an event participant to verify the other calendar event(s). Upon receiving an approval notification from the event participant 410 to schedule the other calendar event(s), the other calendar event(s) may be created. Alternatively, the inference engine 411 may create the other calendar event(s) automatically without any input from the event participant 410.

As discussed above, the productivity service may be employed to perform operations to automate update of a calendar event. An increased user efficiency with the client interfaces of the productivity service 102 may occur as a result of automatically updating the calendar event based on an update signal from a service provider or an email with an update. The update may change an attribute of an activity encompassed by the calendar event. Additionally, automatically updating the calendar event, by the productivity service 102, may reduce processor load, increase processing speed, conserve memory, reduce network bandwidth usage, and/or similar ones.

Embodiments, as described herein, address a need that arises from a lack of efficiency to automatically update a calendar event. The actions/operations described herein are not a mere use of a computer, but address results that are a direct consequence of software used as a service offered to large-numbers of users and applications.

The example scenarios and schemas in FIG. 1 through 4 are shown with specific components, data types, and configurations. Embodiments are not limited to systems according to these example configurations. Automatically updating a calendar event may be implemented in configurations employing fewer or additional components in applications and user interfaces. Furthermore, the example schema and components shown in FIG. 1 through 4 and their subcomponents may be implemented in a similar manner with other values using the principles described herein.

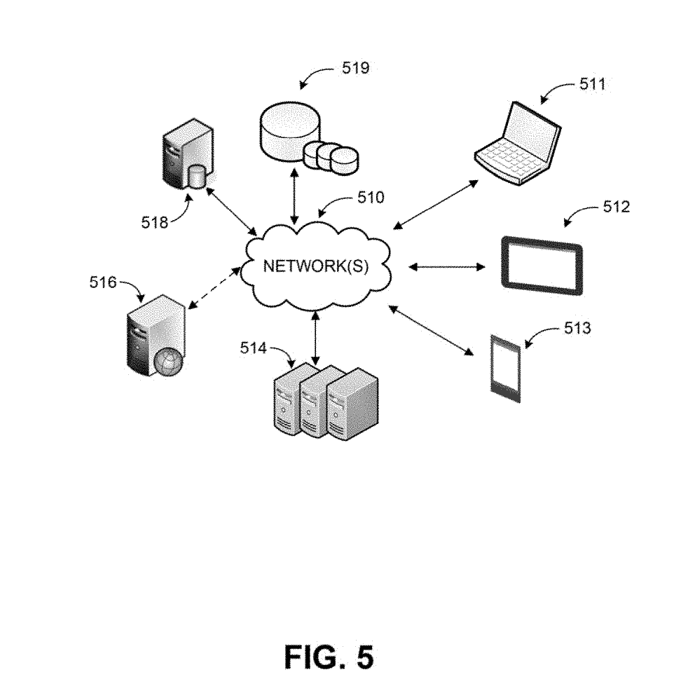

FIG. 5 is an example networked environment, where embodiments may be implemented. A productivity service configured to automatically update a calendar event may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A productivity service may analyze a calendar event to identify a contextual information associated with the calendar event. A service provider associated with the contextual information may be queried for au update signal associated with the calendar event. Upon receiving the update signal associated with the calendar event, the calendar event may be updated based on the update signal.

In an alternative scenario, the productivity service may process a content of a received email. Event information may be identified within the content of the email. The event information may relate to the calendar event. Next, an update to the calendar event may be detected within the event information. The update may be applied to the calendar event. The productivity service may store data associated with the calendar event in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to automatically update a calendar event. Furthermore, the networked environments discussed in FIG. 5 are for illustration purposes only. Embodiments are not limited to the example applications, modules, or processes.

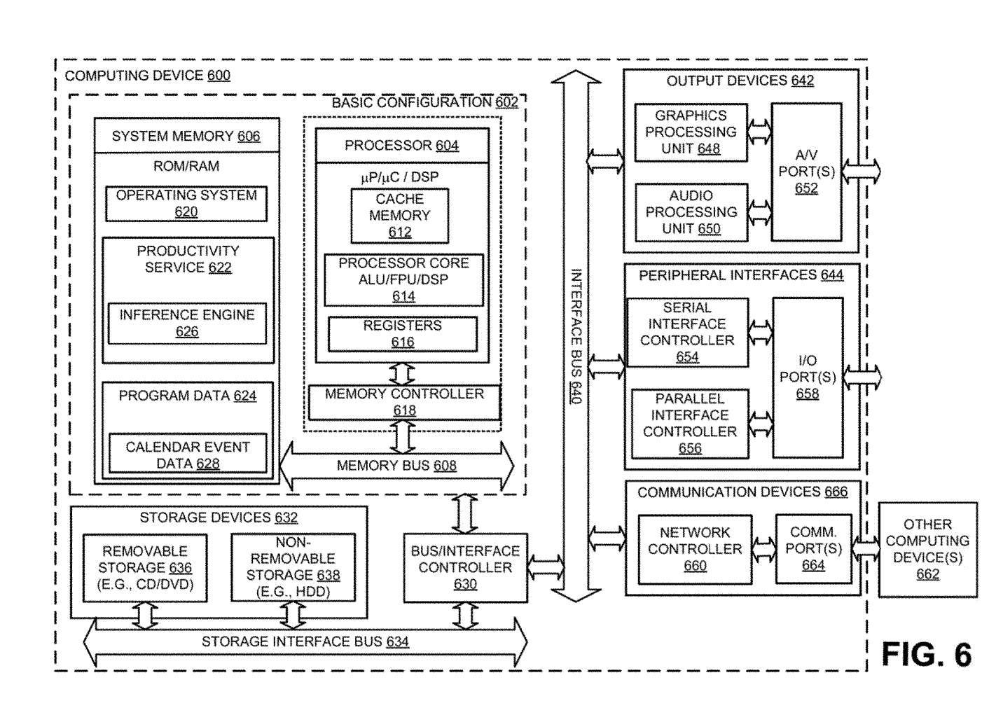

FIG. 6 is a block diagram of an example computing device, which may be used to automatically update a calendar event, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include a component such as an inference engine 626. The inference engine 626 may execute the processes associated with the productivity service 622. The inference engine 626 may analyze a calendar event to identify a contextual information associated with the calendar event. A service provider associated with the contextual information may be queried for an update signal associated with the calendar event. Upon receiving the update signal associated with the calendar event, the calendar event may be updated based on the update signal.

In an alternative scenario, the inference engine 626 may process a content of a received email. Event information may be identified within the content of the email. The event information may relate to the calendar event. Next, an update to the calendar event may be detected within the event information. The update may be applied to the calendar event.

Input to and output out of the productivity service 622 may be transmitted through a communication module associated with the computing device 600. An example of the communication module may include a communication device 666 that may be communicatively coupled to the computing device 600. The communication module may provide wired and/or wireless communication. The program data 624 may also include, among other data, calendar event data 628, or the like, as described herein. The calendar event data 628 may include a start time, an end time, and/or a duration, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to automatically update a calendar event, These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

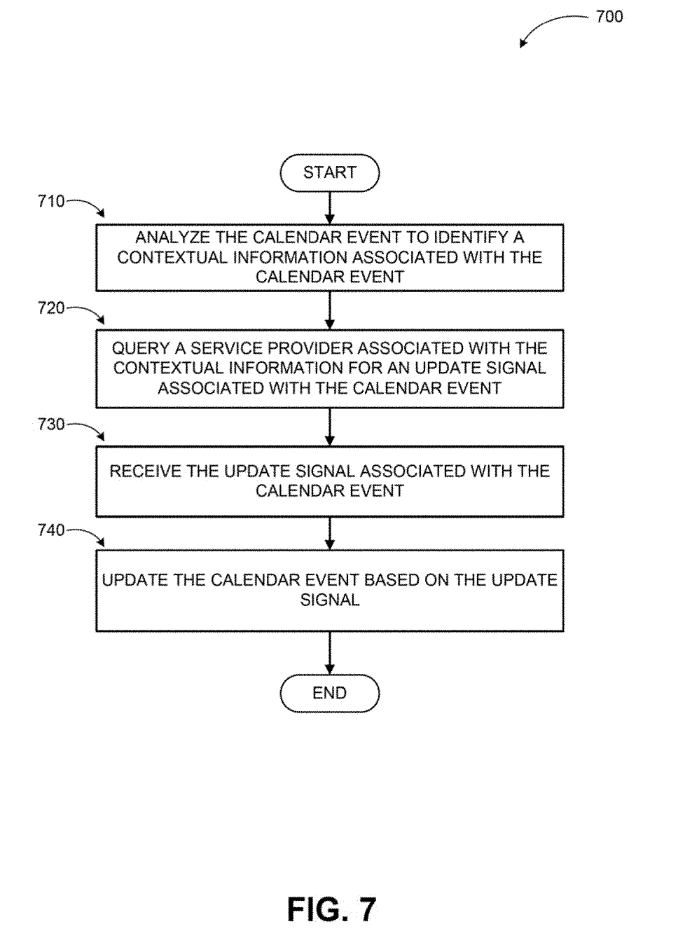

FIG. 7 is a logic flow diagram illustrating a process for automatically updating a calendar event with an update signal, according to embodiments. Process 700 may be implemented on a computing device, such as the computing device 600 or another system.

Process 700 begins with operation 710, where the productivity service may analyze the calendar event to identify a contextual information associated with the calendar event. The contextual information may include a description of attributes of the calendar event. Next, at operation 720, a service provider associated with the contextual information may be queried for an update signal associated with the calendar event. The update signal may include a change to an attribute of the calendar event.

At operation 730, the update signal associated with the calendar event may be received from the service provider. At operation 740, the calendar event may be updated based on the update signal. Any conflicts that result from the update operation may be resolved by re-scheduling an activity encompassed by the calendar event through the service provider and adjusting the calendar event according to the re-scheduled activity.

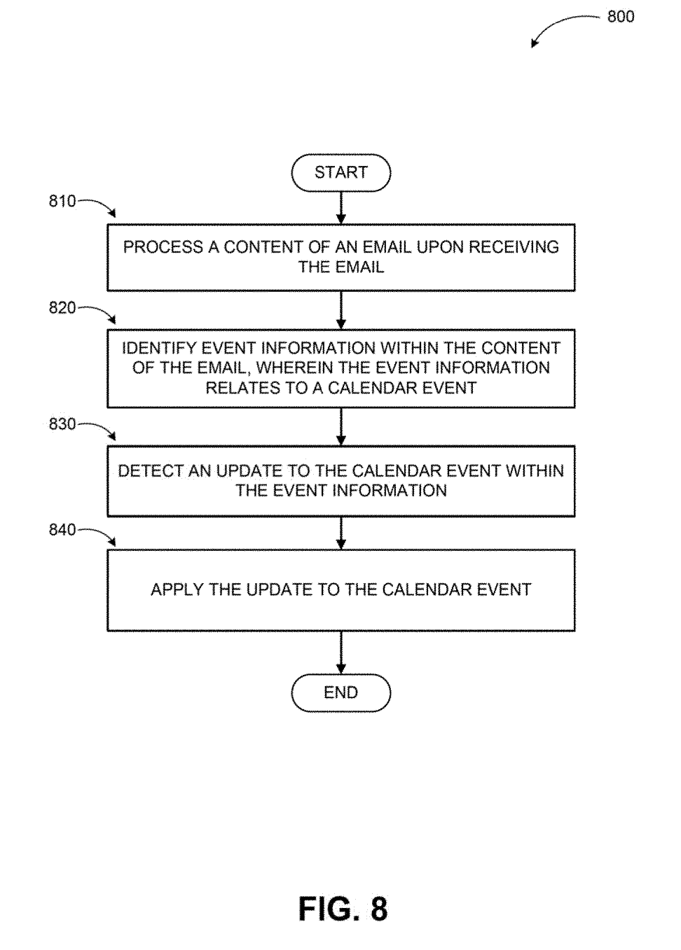

FIG. 8 is a logic flow diagram illustrating a process for automatically updating a calendar event with an update detected within an email, according to embodiments. Process 600 may be implemented on a computing device, such as the computing device 600 or another system.

Process 800 begins with operation 810, where the productivity service may process a content of an email upon receiving the email. At operation 820, event information may be identified within the content of the email. The event information may relate to the calendar event. At operation 830, an update to the calendar event may be detected within the event information. At operation 840, the update may be applied to the calendar event.

The operations included in processes 700 and 800 are for illustration purposes. Automatically updating a calendar event may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a physical server to automatically update a calendar event is described. The physical server includes a communication module configured to facilitate exchange of information associated with the calendar event and other data with computing devices, a memory configured to store instructions associated with a productivity service, and a processor coupled to the memory and the communication module. The processor executes the productivity service in conjunction with the instructions stored in the memory. The productivity service includes an inference engine. The inference engine is configured to process a content of an email upon receiving the email through the communication module, identify event information within the content of the email, where the event information relates to the calendar event, detect an update to the calendar event within the event information, and apply the update to the calendar event.

In other examples, the update includes a change to one or more of: a location, a duration, a start time, an end time, an event name, the service provider, and a task associated with the calendar event. The inference engine is further configured to process the content of the email with a machine learning scheme to identify the update to the calendar event. The inference engine is further configured to match a recipient of the email to an event participant of the calendar event and correlate a contextual information associated with a subject of the email to a contextual information associated with a description of the calendar event.

In further examples, the inference engine is further configured to process a content of a new email, identify event information within the content of the new email, detect a new update to the calendar event within the event information, and apply the new update to the calendar event. The inference engine is further configured to process the content of the email, detect a change to an attribute of the calendar event within the content of the email, and apply the change to the attribute of the calendar event. The attribute includes one or more of: a start time, an end time, and a duration of the calendar event.

In other examples, the inference engine is further configured to detect a conflict between the calendar event and other calendar event, identify an activity within the calendar event, where the activity is reserved with a service provider, and transmit, through the communication module, a notification to the service provider to reschedule the activity to resolve the conflict. The inference engine is further configured to receive, through the communication module, a reschedule confirmation from the service provider and update the calendar event based on one or more of a new start time, a new end time, and a new duration associated with the activity that is rescheduled, The inference engine is further configured to receive, through the communication module, a failure notification to reschedule the activity from the service provider and remove the calendar event. The activity includes one or more of a travel booking, a meeting, an item tracking, and a task.

In some examples, a method executed on a computing device to automatically update a calendar event. The method includes processing a content of an email, identifying event information within the content of the email, where the event information relates to the calendar event, detecting an update to the calendar event within the event information, where the update includes one or more of: a start time, an end time, and a duration associated with an activity within the calendar event, and applying the update to the calendar event.

In other examples, the method further includes detecting other activity associated with the activity within the content of the email and scheduling other calendar event to encapsulate the other activity. The method further includes identifying a pattern associated with an event participant within the email based on the content of the email and transmitting a notification to the event participant, where the notification requests the event participant to authorize creation of a new calendar event based on the pattern. The method further includes receiving an approval notification from the event participant and creating the new calendar event based on the pattern.

In further examples, the method further includes detecting a recurrence associated with the activity within the content of the email and scheduling other calendar events associated with the calendar event, where the calendar event and the other calendar events replicate the recurrence. The method further includes transmitting a notification to an event participant to request the event participant to verify the other calendar events and receiving an approval notification from the event participant to schedule the other calendar events.

In some examples, a computer-readable memory device with instructions stored thereon to automatically update a calendar event is described. The instructions include actions that are similar to actions of the method.

In some examples, a means for automatically updating a calendar event is described. The means for automatically updating a calendar event includes a means for processing a content of an email upon receiving the email, a means for identifying event information within the content of the email, where the event information relates to the calendar event, a means for detecting an update to the calendar event within the event information, and a means for applying the update to the calendar event.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A physical server to automatically update a calendar event the physical server comprising:
a communication module configured to facilitate exchange of information associated with the calendar event and other data with computing devices;
a memory configured to store instructions associated with a productivity service;
a processor coupled to the memory and the communication module, the processor executing the productivity service in conjunction with the instructions stored in the memory, wherein the productivity service includes:
an inference engine configured to:
process a content of an email upon receiving the email through the communication module;
identify event information within the content of the email, wherein the event information relates to the calendar event;
detect an update to the calendar event within the event information; and
apply the update to the calendar event.

2. The physical server of claim 1, wherein the update includes a change to one or more of: a location, a duration, a start time, an end time, an event name, the service provider, and a task associated with the calendar event.

3. The physical server of claim 1, wherein the inference engine is further configured to:
process the content of the email with a machine learning scheme to identify the update to the calendar event.

4. The physical server of claim 1, wherein the inference engine is further configured to:
match a recipient of the email to an event participant of the calendar event; and
correlate a contextual information associated with a subject of the email to a contextual information associated with a description of the calendar event.

5. The physical server of claim 1, wherein the inference engine is further configured to:
process a content of a new email;
identify event information within the content of the new email;
detect a new update to the calendar event within the event information; and
apply the new update to the calendar event.

6. The physical server of claim 1 wherein the inference engine is further configured to:
process the content of the email;
detect a change to an attribute of the calendar event within the content of the email; and
apply the change to the attribute of the calendar event.

7. The physical server of claim 6, wherein the attribute includes one or more of: a start time, an end time, and a duration of the calendar event.

8. The physical server of claim 1, wherein the inference engine is further configured to:
detect a conflict between the calendar event and other calendar event;
identify an activity within the calendar event, wherein the activity is reserved with a service provider; and
transmit, through the communication module, a notification to the service provider to reschedule the activity to resolve the conflict.

9. The physical server of claim 8, wherein the inference engine is further configured to:
receive, through the communication module, a reschedule confirmation from the service provider; and
update the calendar event based on one or more of a new start time, a new end time, and a new duration associated with the activity that is rescheduled.

10. The physical server of claim 9, wherein the inference engine is further configured to:
receive, through the communication module, a failure notification to reschedule the activity from the service provider; and
remove the calendar event.

11. The physical server of claim 9, wherein the activity includes one or more of a travel booking, a meeting, an item tracking, and a task.

12. A method executed on a computing device to automatically, update a calendar event, the method comprising:
processing a content of an email;
identifying event information within the content of the email, wherein the event information relates to the calendar event;
detecting an update to the calendar event within the event information, wherein the update includes one or more of: a start time, an end time, and a duration associated with an activity within the calendar event; and
applying the update to the calendar event.

13. The method of claim 12, further comprising:
detecting other activity associated with the activity within the content of the email; and
scheduling other calendar event to encapsulate the other activity.

14. The method of claim 12, further comprising:
identify a pattern associated with an event participant within the email based on the content of the email; and
transmitting a notification to the event participant, wherein the notification requests the event participant to authorize creation of a new calendar event based on the pattern.

15. The method of claim 14, further comprising:
receiving an approval notification from the event participant; and
creating the new calendar event based on the pattern.

16. The method of claim 12, further comprising:
detecting a recurrence associated with the activity within the content of the email; and
scheduling other calendar events associated with the calendar event, wherein the calendar event and the other calendar events replicate the recurrence.

17. The method of claim 16, further comprising:
transmitting a notification to an event participant to request the event participant to verify the other calendar events; and
receiving an approval notification from the event participant to schedule the other calendar events.

18. A computer-readable Memory device with instructions stored thereon to automatically update a calendar event, the instructions comprising:
processing a content of an email;
identifying event information within the content of the email, wherein the event information relates to the calendar event;
detecting an update to the calendar event within the event information, wherein the update includes one or more of: a start time, an end time, and a duration associated with an activity within the calendar event; and
applying the update to the calendar event.

19. The computer-readable memory device of claim 18, wherein the instructions further comprise:
detecting a conflict between the calendar event and other calendar event;
transmitting a notification to a service provider to reschedule the activity to resolve the conflict, wherein the activity is reserved with the service provider;
receiving a reschedule confirmation from the service provider; and
updating the calendar event based on one or more of a new start time, a new end time, and a new duration associated with the activity that is rescheduled.

20. The computer-readable memory device of claim 18, wherein the instructions further comprise:
identifying a pattern associated with an event participant within the email based on the content of the email;
transmitting a notification to the event participant, wherein the notification requests the event participant to authorize creation of a new calendar event based on the pattern;
receiving an approval notification from the event participant; and
creating the new calendar event based on the pattern.
